(19) United States
(12) Patent Application Publication
(10) Pub. No.: US 2025/0136129 A1
(43) Pub. Date: May 1, 2025

(54) CONTROL DURING ONE PEDAL DRIVE MODE ON ROAD GRADES

(71) Applicant: FORD GLOBAL TECHNOLOGIES, LLC, Dearborn, MI (US)

(72) Inventors: Sergey Gennadievich Semenov, Farmington Hills, MI (US); Barry Shepherd, Madison, WI (US); Richard B. Eckenrode, Royal Oak, MI (US)

(21) Appl. No.: 18/494,900

(22) Filed: Oct. 26, 2023

(51) Int. Cl. B60W 50/10

(52) U.S. Cl. CPC B60W 50/10; B60W 2552/15; B60W 2710/083

(57) ABSTRACT

A vehicle includes a powerplant, an accelerator pedal, a sensor associated with the accelerator pedal and configured to output data indicative of accelerator pedal position, and a controller. The controller is programmed to command a torque that includes a gravitational-offset component to the powerplant when the vehicle is on non-flat road grade, wherein the torque is commanded such that the gravitational-offset component converges towards zero as the accelerator pedal position increases.

### TECHNICAL FIELD

This disclosure relates to vehicle torque controls that compensate for gravity.

### BACKGROUND

Electrified vehicles, such as fully electric and hybrid electric vehicles, include at least one electric machine for propelling the vehicle. The electric machine is powered by a traction battery that supplies energy to the electric machine, which reduces a state of charge (SOC) of the battery. Many electrified vehicles are capable of regenerative braking to recharge the battery by converting mechanical power into electrical power. Some electric vehicles offer one-pedal driving.

### SUMMARY

According to one embodiment, a vehicle includes a powerplant and a controller. The controller is programmed to, in response to the vehicle being on an uphill grade, command a torque to the powerplant based on a driver-demanded wheel torque plus a compensation torque to mitigate a gravitational resistance associated with the uphill grade, wherein the compensation torque is derived from a resistance torque corresponding to the gravitational resistance less a value based on the driver-demanded torque.

According to another embodiment, a vehicle includes a powerplant, an accelerator pedal, a sensor associated with the accelerator pedal and configured to output data indicative of accelerator pedal position, and a controller. The controller is programmed to command a torque that includes a gravitational-offset component to the powerplant when the vehicle is on non-flat road grade, wherein the torque is commanded such that the gravitational-offset component converges towards zero as the accelerator pedal position increases.

A method for offsetting gravitation effects in vehicles includes commanding a torque that includes a gravitational-offset component to a powerplant of a vehicle when the vehicle is on non-flat road grade, wherein the torque is commanded such that the gravitational-offset component converges towards zero as an accelerator pedal position increases.

### BRIEF DESCRIPTION OF THE DRAWINGS

FIG. 1 illustrates a schematic diagram of an example electrified vehicle.

FIG. 2 illustrates a schematic diagram of various torques present at a driven wheel of the vehicle.

FIG. 3 is a flowchart of an algorithm for calculating a gravitational-resistance torque associated with a road grade.

FIG. 4 is a flowchart of an algorithm for calculating a commanded wheel torque that accounts for effects of gravity.

FIG. 5 is a plot of wheel torques for a downhill grade.

FIG. 6 is a plot of wheel torques for an uphill grade.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Traditionally, drivers controlled the vehicle speed by modulating accelerator and brake pedals. The driver depresses the accelerator pedal to go faster and applies the brake pedal to slow down. Modern vehicles present an opportunity for an alternative control called one-pedal driving (one-pedal driving mode) in which the vehicle can be controlled using only the accelerator pedal to both accelerate and decelerate the vehicle. In the one-pedal driving mode, the driver commands a raw driver-demanded wheel torque by actuating the accelerator pedal. Depending upon the vehicle speed and the accelerator pedal position, the raw driver-demanded torque may be a positive value or a negative value. A positive value indicates a propulsion torque, whereas a negative value indicates a braking torque. (A negative driver-demanded torque may also be referred to herein as “a target braking torque.”). The vehicle may provide the target braking torque using either the powertrain, e.g., regenerative braking, the friction brakes, or a combination of both.

The raw driver-demanded torque may be filtered and rate limited to smooth the acceleration and deceleration of the vehicle. Once filtered and rate limited, the torque may be referred to as a “commanded wheel torque.” The rate limit constrains the step change between the previous commanded wheel torque and the subsequent commanded wheel torque. The vehicle may be programmed with a plurality of different filters and rate limits that are applied in difference situations. For example, different filters and rate limits may be used depending upon the vehicle speed, e.g., a lower rate limit may be used when the vehicle is at low speed and a higher rate limit may be used when the vehicle is at high speeds. (A higher rate limit permits a larger step change than a lower rate limit.) Different filters and rate limits may also be used based on the mode of the vehicle. That is, the vehicle may include a set of rate limits and filters when the vehicle is in a two-pedal drive mode and may use another set of rate limits and filters when the vehicle is in a one-pedal drive mode.

The one-pedal drive mode may be configured to bring the vehicle to a complete stop when the driver has released the accelerator pedal without application of the brake pedal. The vehicle may be stopped using regenerative braking, friction braking, or both. Once the vehicle is stopped, the friction brakes may be applied to hold the vehicle stationary.

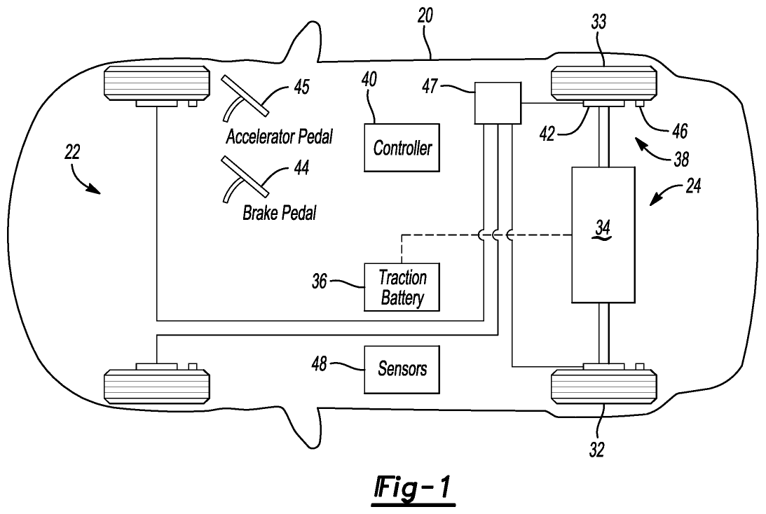

Referring to FIG. 1, an electrified vehicle 20 is illustrated as a fully electric vehicle but, in other embodiments, the vehicle 20 may be a hybrid-electric vehicle that includes an internal-combustion engine, or a conventionally powered vehicle that only includes an engine. The vehicle 20 is shown as being two-wheel drive (such as front-wheel drive or rear-wheel drive) but may be all-wheel drive (AWD) in other embodiments. The vehicle 20 may include a powertrain 24 including a powerplant, e.g., an electric machine 34, capable of operating to accelerate (propel) and brake the vehicle 20.

The electric machine 34 is operably coupled to driven wheels 30 and 32. A gearbox (not shown) may be included to change a speed ratio between the electric machine 34 and the wheels 30, 32. The gearbox may include one or more speed ratios. The electric machine may be one or more electric machines. The electric machine 34 is capable of acting as motor to provide a positive torque to propel the vehicle 20 and is capable of acting as a generator to provide a negative torque to brake the vehicle such as via regenerative braking. The electric machine 34 may be a permanent magnet three-phase alternating current (AC) electric motor or other suitable type.

The electric machine 34 is powered by one or more traction batteries, such as traction battery 36. The traction battery 36 stores energy that can be used by the electric machine 34. The traction battery 36 may provide a high-voltage direct current (DC) output from one or more battery cell arrays, sometimes referred to as battery cell stacks, within the traction battery 36. The battery cell arrays include one or more battery cells. The battery cells, such as a prismatic, pouch, cylindrical, or any other type of cell, convert stored chemical energy to electrical energy. The cells may include a housing, a positive electrode (cathode), and a negative electrode (anode). An electrolyte allows ions to move between the anode and cathode during discharge, and then return during recharge. Terminals may allow current to flow out of the cell for use by the vehicle 20. Different battery pack configurations may be available to address individual vehicle variables including packaging constraints and power requirements. The battery cells may be thermally adjusted with a thermal management system.

The traction battery 36 may be electrically connected to one or more power-electronics modules through one or more contactors. The module may be electrically connected to the electric machine 34 and may provide the ability to bi-directionally transfer electrical energy between the traction battery 36 and the electric machine 34. For example, a traction battery 36 may provide a DC voltage while the electric machine 34 may require a three-phase AC. The power-electronics module may convert the DC voltage to a three-phase AC voltage as required by the electric machines. In a generator mode, which may be during regenerative braking, the power-electronics module may convert the three-phase AC voltage from the electric machine 34 acting as a generator to the DC voltage required by the traction battery 36.

The vehicle 20 includes one or more controllers 40 in electric communication with a plurality of vehicle systems and is configured to coordinate functionality of the vehicle. The controller 40 may be a vehicle-based computing system that includes one or more controllers that communicate via a serial bus (e.g., controller area network (CAN)) or via dedicated electrical conduits. The controller 40 generally includes any number of microprocessors, ASICs, ICs, memory (e.g., FLASH, ROM, RAM, EPROM and/or EEPROM) and software code to co-act with one another to perform a series of operations. The controller 40 also includes predetermined data, or “lookup tables,” that are based on calculations and test data, and are stored within the memory. The controller 40 may communicate with other vehicle systems and controllers over one or more wired or wireless vehicle connections using common bus protocols (e.g., CAN and LIN). Used herein, any reference to “a controller” refers to one or more controllers. The controller 40 may include battery energy control module (BECM) that operates at least the traction battery, a powertrain control module (PCM) that operates at least the electric machine, and a brake control module that controls the braking system 38.

The controllers communicate with various vehicle sensors and actuators via an input/output (I/O) interface that may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to the CPU. Although not explicitly illustrated, those of ordinary skill in the art will recognize various functions or components that may be controlled by a controller within each of the subsystems identified above.

The braking system 38 may be a hydraulic system, an electric system, or a combination of electric and hydraulic. The braking system 38 is a brake-by-wire system that uses pedal sensors and actuators to engage the brakes rather than a direct mechanical connection between the brake pedal and the master cylinder. Alternatively, the braking system 38 may be conventional.

The brake system 38 may include a master cylinder 47 in fluid communication with a plurality of friction brakes 42 located at each of the wheels. The master cylinder 47 may be actuated by directly by the brake pedal or in directly by the controller 40 based on the received data from the accelerator and brake pedal sensors as well as other factors. Modern vehicles typically have disc brakes; however, other types of friction brakes are available, such as drum brakes. In an example embodiment, each of the brakes 42 are in fluid communication with a valve body (not shown) via brake lines configured to deliver fluid pressure from the master cylinder 47 to a caliper of the brakes 42. The valve body may include a plurality of valves configured to provide independent fluid pressure to each of the brakes 42 according to ABS. The braking system 38 also includes associated wheel-speed sensors 46 each located at one of the wheels. Each sensor 46 is configured to output a wheel-speed signal to the controller 40 indicative of a measured wheel speed.

The vehicle 20 is configured to brake using powertrain braking (e.g., regenerative braking), friction braking, or a combination thereof. The brake control module includes programming for aggregating a demanded braking torque between the electric machine 34 and the friction brakes 42. The demanded braking torque may be based on driver input, e.g., a position of the brake pedal 44, or by the controller 40 in a two-pedal driving mode. The aggregator may be programmed to slow the vehicle using regenerative braking whenever possible and apply the friction brakes 42 when necessary.

The vehicle 20 includes an accelerator pedal 45. The accelerator pedal 45 includes a range of travel from a released position to a fully depressed position and indeterminate positions therebetween. The released position may be considered a zero percent position and the fully depressed position may be considered a 100 percent position. Releasing the pedal may be referred to as decreasing the accelerator pedal position, and applying the pedal may be referred to as increasing the accelerator pedal position. The accelerator pedal 45 includes an associated sensor (not shown) that senses the position of the pedal 45. The sensor is configured to output a pedal-position signal to the controller 40 that is indicative of a sensed position of the pedal 45, i.e., an accelerator pedal position. The accelerator pedal 45 is used by the driver to command a desired speed and torque of the vehicle. That is, the accelerator pedal 45 is used by the driver to set a driver-demanded wheel torque (DDT). The driver-demanded torque may be a positive value or a negative value. A positive value indicates a propulsion torque, whereas a negative value indicates a braking torque. (A negative driver-demanded torque may also be referred to herein as “a target braking torque.”)

The controller 40 may be programmed to receive the pedal-position signal and determine the driver-demanded torque based on pedal position and other factors such as vehicle speed. During a one-pedal driving mode, the accelerator pedal is used to set a target vehicle propulsion torque when the driver-demanded torque is positive was well as a target braking torque when the driver-demanded torque is negative. The controller 40 may include multiple lookup tables or maps for determining the driver-demanded torque. These maps indicate the driver-demanded torque based on inputs such as accelerator pedal position, vehicle speed, and other factors. Different maps may be used in different drive modes. For example, one or more maps may be use when the vehicle is in a two-pedal driving mode and another map may be used when the vehicle is in a one-pedal driving mode. The maps associated with the one-pedal drive mode may include more aggressive negative driver-demanded torque values so that the vehicle is braked (powertrain, friction, or both) in response to the accelerator pedal being released so that application of the brake pedal is unnecessary in most situations.

The vehicle may include a human machine interface (HMI) for manually activating or deactivating the one-pedal driving mode. For example, the vehicle may include a touchscreen head unit with various menus and settings. One of these settings may be the activation or deactivation of one-pedal driving. For example, one of the menus may include a selectable icon of a capacitive touchscreen that can be selected to activate and deactivate the one-pedal driving mode.

Most roadways follow the natural topography of the terrain resulting in uphill and downhill road segments, which have a grade relative to flat ground. Uphill road segments have a positive road grade, whereas downhill road segments have a negative road grade. All things being equal, a vehicle will slow down when going uphill and will speed up going downhill due to the force of gravity. Therefore, a driver seeking to maintain a constant speed would traditionally increase the driver-demanded torque when going uphill (i.e., further depress the accelerator pedal) and decrease the driver-demanded torque when going downhill (i.e., release the accelerator pedal).

The vehicle 20 may include one or more sensors 48 configured to determine accelerations of the vehicle. For example, the sensors 48 may include a yaw-rate sensor, a lateral-acceleration sensor, a longitudinal-acceleration sensor, a pitch sensor, and a roll sensor. The yaw-rate sensor generates a yaw-rate signal corresponding to the yaw rate of the vehicle. Using the yaw rate sensor, the yaw acceleration may also be determined. The lateral-acceleration sensor outputs a lateral-acceleration signal corresponding to the lateral acceleration of the vehicle. The longitudinal-acceleration sensor generates a longitudinal-acceleration signal corresponding to the longitudinal acceleration of the vehicle. The pitch sensor generates a signal corresponding to the pitch of the vehicle, and the roll sensor generates a signal corresponding to the roll of the vehicle. The various sensors are in communication with the controller 40. In some embodiments, the yaw rate, lateral acceleration, longitudinal acceleration, the pitch, the roller and other measurements may be measured by a single sensor.

The one or more sensors 48 may be used by the controller 40 to determine a grade of the road, e.g., flat, uphill, or downhill. Road grade may be determined by comparing accelerometer-based longitudinal acceleration (which includes the effects of gravity) to acceleration derived from motor speed (which does not include the effects of gravity). The difference between those two accelerations yields the acceleration component due to gravity which can be converted to an equivalent wheel torque by multiplying by vehicle mass and tire radius.

The vehicle 20 is configured to aid the driver in maintaining constant speed by applying a compensation torque overtop of the driver-demanded torque to account for the force of gravity.

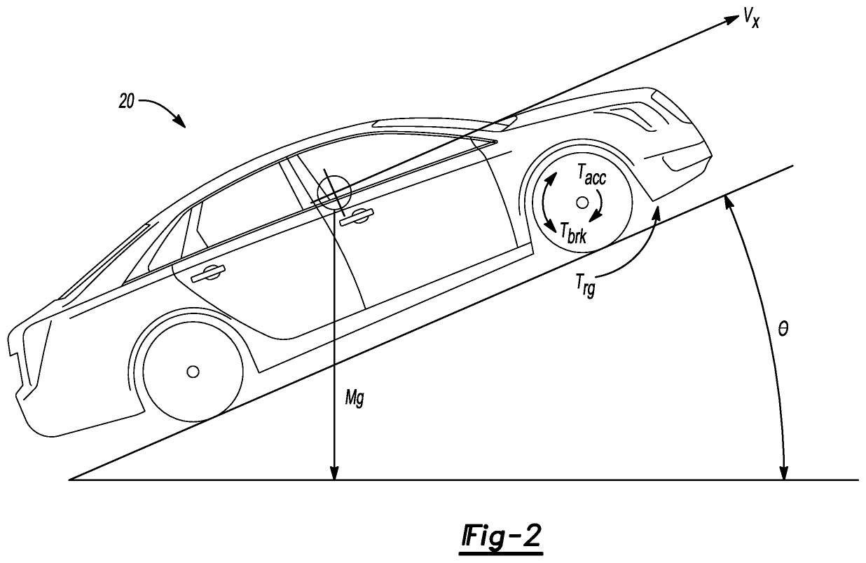

Referring to FIG. 2, the vehicle 20 is shown stopped on an inclined surface and illustrated with a number of forces and moments acting thereon. The surface has a gradient θ, which may also be referred to as a road grade. Here, the road grade is uphill, which refers to increasing elevation in a forward direction of travel. A downhill road grade refers to decreasing elevation in the forward direction. The resultant torque at the wheels of the vehicle, Tᵥₑₕ, may be calculated using equation 1 as shown below:

$${T}_{veh} = {T}_{acc} + {T}_{brk} - {T}_{rg} \qquad ( Eq . 1 )$$

Where T_{acc} represents the propulsion torque provided by the powertrain, T_{brk} is the brake torque provided by the vehicle brake system(s), and T_{rg} is the torque acting on the vehicle due to road grade or external forces. T_{rg} may be referred to as road-grade torque. In the uphill example, T_{acc} is depicted as a positive or clockwise moment, and T_{rg} is depicted as negative or counter-clockwise moments. T_{brk} acts against the rotation of the wheels and would therefore act as a clockwise moment about the wheels when the vehicle is urged in a rearward direction by T_{rg}, and T_{brk} would act as a counter-clockwise moment about the wheels when the vehicle is propelled in a forward direction. Although each moment is illustrated about a front axle of the vehicle 20, one or more of theses moments may act about both the front and rear axles. If the vehicle 20 is at standstill, Tᵥₑₕ is equal to zero and the primary road load is due to gravity. Equation 2 represents an equation for calculating the road-grade torque (T_{rg}):

$${T}_{rg} = Mg Sin ( θ ) * {R}_{w} \qquad ( Eq . 2 )$$

Where M is the mass of the vehicle; g is the acceleration due to gravity; θ is road gradient; and R_{w} is the radius of the drive wheels.

One use case for torque compensation is to prevent rollback of the vehicle when stopped on a hill. Here, the controller 40 delays releasing of the brakes until the propulsion torque T_{acc} exceeds the road-grade torque T_{rg}. The propulsion torque required to counteract road grade and prevent rollback may be referred to as a grade-compensation wheel torque. In the case of rollback mitigation, the grade-compensation wheel torque is equal to the road-grade torque albeit in an opposite direction of rotation.

Another use case is to help the driver maintain a constant speed when moving by adding or subtracting torque (based on the road grade) overtop the driver-demanded torque (based mainly on accelerator pedal position). The value of the grade-compensation wheel torque may vary between a full compensation and a partial compensation. Full grade compensation refers to a torque that is equal to the effect of gravity. Partial compensation refers to a value that is less than the full compensation and does not fully account for the effects of gravity.

In general, when full grade compensation is applied on top of the driver-demanded torque, a driver may maintain a constant pedal position despite the road grade and the vehicle will generally maintain a constant speed to due to the controller adding and subtracting torque as necessary to compensate for gravity. One potential drawback of full grade compensation is that drivers akin to conventional vehicles may find it unintuitive when the vehicle does not decelerate upon entering an uphill grade and accelerate upon entering a downhill grade. This drawback can be mitigated by only applying a partial grade compensation so that the vehicle experiences some of the acceleration and deceleration expected from changes in road grade. Partial grade compensation may reduce driver effort and facilitate speed consistency by supplying some but not all of the torque required to mitigate the effects of gravity so that less accelerator pedal change is required. When partial grade compensation is applied, the vehicle will still experience some acceleration/deceleration in response to road grade thus providing a more traditional feel to the driver than full compensation.

Control logic or functions performed by controller 40 may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based vehicle, engine, and/or powertrain controller, such as controller 40. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the vehicle or its subsystems. The computer-readable storage devices or media may include one or more of a number of known physical devices which utilize electric, magnetic, and/or optical storage to keep executable instructions and associated calibration information, operating variables, and the like.

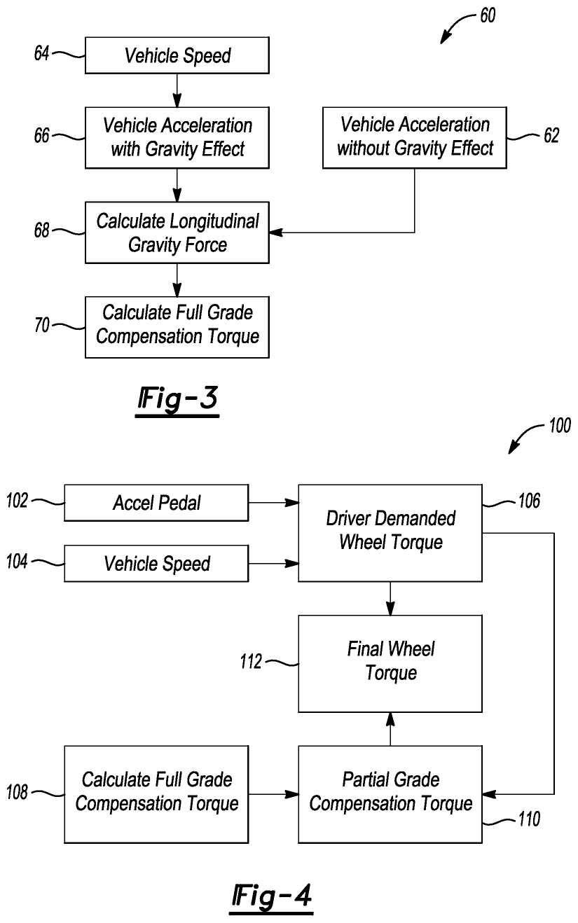

FIG. 3 is a flowchart 60 of an algorithm for calculating the full grade compensation torque. At operation 62, the controller 40 determines the vehicle acceleration without gravity. A method for performing this calculation is to measure the longitudinal vehicle acceleration with the accelerometer, e.g., sensor 48. Alternatively, vehicle acceleration without gravity may be determined by estimating actual total torque applied at the wheels through the powertrain, converting it to the equivalent force applied to the vehicle, and then converting that force into vehicle acceleration by dividing by vehicle mass.

The vehicle speed 64, which may be measured directly or calculated from the electric machine 34 rotational speed, is received at box 66 where the vehicle acceleration with gravity is calculated. At operation 66, the controller calculates the vehicle acceleration as a derivative of the vehicle speed, and difference between the current and previous vehicle speeds divided by the delta in time between the moments when the vehicle speeds have been calculated or measured. The vehicle speed may be filtered with a low-pass filter before calculating the derivative.

In operation 68, the controller 40 calculates the longitudinal gravity force. The longitudinal gravity force may be calculated using equation 3, Massᵥₑₕ is the mass of the vehicle, Accel_{with_G} is the vehicle acceleration with gravity and Accel_{without_G} is vehicle acceleration without gravity along the longitudinal vehicle axis.

$$Longitudinal Gravity Force = {Mass}_{veh} \times ( {Accel}_{with \_ G} - {Accel}_{without \_ G} ) \qquad ( Eq . 3 )$$

At operation 70, the full grade compensation torque is calculated using equation 4, for example.

$$Full Grade Compensation = - Longitudinal Gravity Force \times Tire Radius \qquad ( Eq . 4 )$$

The full grade compensation may be used as a starting point for calculating a partial grade compensation. In order to provide more intuitive driver feel, the partial grade compensation may be based on the driver-demanded torque.

FIG. 4 illustrates a flowchart 100 for calculating a final wheel torque. The controller 40 receives an accelerator pedal position 102 from the sensor associated with the accelerator pedal and receives a measured vehicle speed 104 at box 106. The controller calculates the driver-demanded torque at operation 106 based on the accelerator pedal position 102 and the vehicle speed 104 as discussed above. At operation 108, the controller calculates the full grade compensation as explained in FIG. 3.

At operation 110, the controller calculates the partial grade compensation torque. The partial grade compensation torque may be based on the full grade compensation that is reduced by a value based on the driver-demanded torque and a gain as shown below in equation 5.

$$Partial Grade Compensation = Full Grade Compensation - ( gain \times DDT ) \qquad ( Eq . 5 )$$

At operation 112, the final wheel torque command is calculated based on the driver-demanded torque of operation 106 and the partial grade compensation torque of operation 110 as shown in equation 6. The grade compensation torque (full or partial) may be referred to as gravitational-offset component of the final torque command.

$$Full Wheel torque = DDT + Partial Grade Compensation \qquad ( Eq . 6 )$$

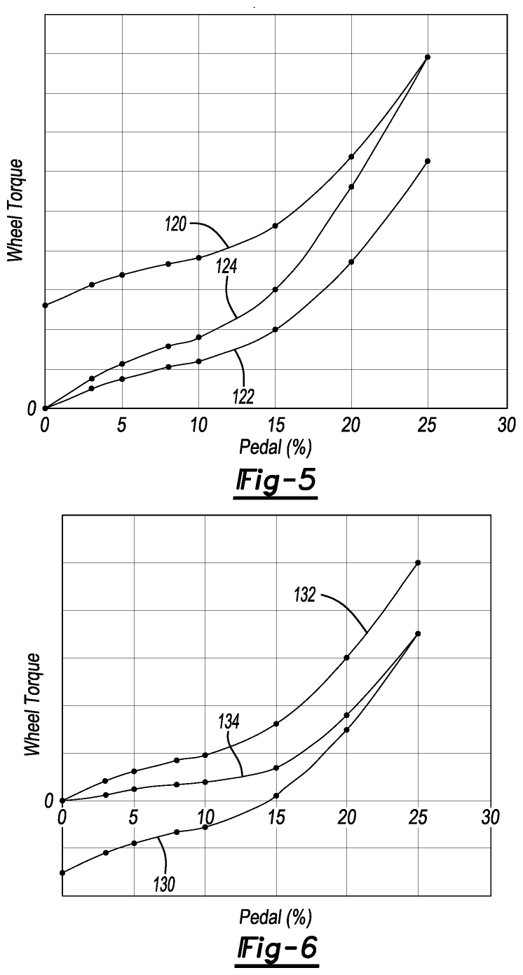

FIGS. 5 and 6 illustrate how the final wheel torque is affected by no grade compensation, full grade compensation, and partial grade compensation for example driving scenario. The plots show wheel torque on the y-axis and accelerator pedal position (as a percentage) on the x-axis.

Referring to FIG. 5, trace 120 shows the uncompensated wheel torque, which is a combination of the driver-demanded wheel torque and the gravity force translated to the wheels as an extra wheel torque, for simplicity. Trace 122 shows the wheel torque when full grade compensation is applied, which is the driver-demanded wheel torque. Since this example is downhill grade, the extra gravity wheel torque is positive and the fully compensated wheel torque is less than the uncompensated torque. Trace 124 shows the wheel torque when partial grade compensation is applied. The partially compensated wheel torque 124 is between the uncompensated wheel torque 120 and the fully compensated torque 122. As shown in the graph, the partially compensated torque 124 coincides with the fully compensated torque 122 when the pedal position is 0% and converges towards the uncompensated torque 120 as the accelerator pedal is further depressed. That is, the gravitational-offset component of the torque command converges towards zero as the accelerator pedal position increases.

FIG. 6 shows the vehicle on an uphill grade. In this example, the uncompensated wheel torque shown by trace 130, the fully compensated wheel torque is shown by trace 132, and the partially compensated wheel torque shown by trace 134. Since this example is uphill, the traces are generally inverse to the downhill example, wherein the fully compensated wheel torque 132 has the highest values and the uncompensated wheel torque 130 has the lowest values. Similar to the example of FIG. 5, the partially compensated torque has values closer to the fully compensated torque for lower pedal positions and converges towards the uncompensated wheel torque 130 as the pedal further depressed. That is, the gravitational-offset component of the torque command converges towards zero as the accelerator pedal position increases.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a powerplant; and
a controller programmed to, in response to the vehicle being on an uphill grade, command a torque to the powerplant based on a driver-demanded wheel torque plus a compensation torque to mitigate a gravitational resistance associated with the uphill grade, wherein the compensation torque is derived from a resistance torque corresponding to the gravitational resistance less a value based on the driver-demanded torque.

2. The vehicle of claim 1, wherein the controller is further programmed to, in response to the vehicle being on a downhill grade, command another torque to the powerplant based on the driver-demanded wheel torque less another compensation torque to mitigate a gravitational assistance associated with the downhill grade, wherein the another compensation torque is derived from an assistance torque corresponding to the gravitational assistance less a value based on the driver-demanded torque.

3. The vehicle of claim 1, wherein the compensation torque is equal to the resistance torque less the driver-demanded torque multiplied by a gain.

4. The vehicle of claim 3, wherein the gain is a predetermined value.

5. The vehicle of claim 3, wherein the gain is based on the driver-demanded torque.

6. The vehicle of claim 1 further comprising an accelerometer.

7. The vehicle of claim 6, wherein the controller is further programmed to calculate the resistance torque based on data from the accelerometer.

8. The vehicle of claim 1, wherein the powerplant is an electric machine.

9. A vehicle comprising:
a powerplant;
an accelerator pedal;
a sensor associated with the accelerator pedal and configured to output data indicative of accelerator pedal position; and
a controller programmed to command a torque that includes a gravitational-offset component to the powerplant when the vehicle is on non-flat road grade, wherein the torque is commanded such that the gravitational-offset component converges towards zero as the accelerator pedal position increases.

10. The vehicle of claim 9, wherein the gravitational-offset component is less than a gravitational-resistance torque associated with the road grade.

11. The vehicle of claim 9, wherein the gravitational-offset component is based on a gravitational-resistance torque associated with the road grade and a driver-demanded wheel torque.

12. The vehicle of claim 11, wherein the gravitational-offset component is further based on a gain that is a function of the accelerator pedal position.

13. The vehicle of claim 9, wherein the gravitational-offset component is based on a gravitational-resistance torque associated with the road grade and a driver-demanded wheel torque.

14. The vehicle of claim 9, wherein the gravitational-offset component is a positive value when the road grade is uphill and is a negative value when the road grade is downhill.

15. The vehicle of claim 9 further comprising an accelerometer, wherein the gravitational-offset component is based on data from the accelerometer.

16. The vehicle of claim 9, wherein the powerplant is an electric machine.

17. A method for offsetting gravitation effects in vehicles, the method comprising:
commanding a torque that includes a gravitational-offset component to a powerplant of a vehicle when the vehicle is on non-flat road grade, wherein the torque is commanded such that the gravitational-offset component converges towards zero as an accelerator pedal position increases.

18. The vehicle of claim 17, wherein the gravitational-offset component is less than a gravitational-resistance torque associated with the road grade.

19. The vehicle of claim 17, wherein the gravitational-offset component is based on a gravitational-resistance torque associated with the road grade and a driver-demanded wheel torque.

20. The vehicle of claim 19, wherein the gravitational-offset component is further based on a gain that is a function of the accelerator pedal position.
